(19) United States
(12) Patent Application Publication
(10) Pub. No.: US 2012/0304652 A1
(43) Pub. Date: Dec. 6, 2012

(54) INJECTOR APPARATUS

(75) Inventors: Bradley Donald Crawley, Simpsonville, SC (US); David William Cihlar, Greenville, SC (US); Patrick Benedict Melton, Horse Shoe, NC (US); Frederick Millard Setzer, JR., Simpsonville, SC (US)

(73) Assignee: GENERAL ELECTRIC COMPANY, Schenectady, NY (US)

(21) Appl. No.: 13/149,044

(22) Filed: May 31, 2011

(51) Int. Cl. F02C 7/22

(52) U.S. Cl. 60/740

(57) ABSTRACT

An injector apparatus is provided and includes an annular inlet in which a first fluid traveling in a first direction is mixable with a second fluid to form a mixture, an annular outlet disposed downstream from the inlet from which the mixture is injectable into a main flow in a third direction and an annular intermediate section fluidly interposed between the inlet and the outlet and along which the mixture is re-directable from the inlet to the outlet.

### BACKGROUND OF THE INVENTION

The subject matter disclosed herein relates to an injector apparatus.

Emissions compliance in most gas turbine engines can be achieved through various design approaches that address the gas turbine cycle, operational strategy and component design. Factors affecting the gas turbine engine cycle, such as pressure ratio, airflow and exhaust temperature targets, dictate boundary conditions where gas turbine engine components, such as the compressor, combustion system, and turbine are designed to operate.

For gas turbine engines, achieving high efficiency with low emissions has typically been addressed at the component level by the design of combustion systems that use zonal fuel staging to achieve low emissions over operating ranges with dynamics characteristics that are acceptable for long hardware life. In other cases, systems stage fuel and air at different axial locations in the combustor to improve overall fuel/air ratios prior to combustion to aid in achieving lower pollutant emissions and combustion dynamics. In still other cases, combustors have been designed with complex and expensive air bypass systems that bypass air around reaction zones thereby raising flame temperature and reducing pollutant emissions.

### BRIEF DESCRIPTION OF THE INVENTION

According to one aspect of the invention, an injector apparatus is provided and includes an annular inlet in which a first fluid traveling in a first direction is mixable with a second fluid to form a mixture, an annular outlet disposed downstream from the inlet from which the mixture is injectable into a main flow in a third direction and an annular intermediate section fluidly interposed between the inlet and the outlet and along which the mixture is re-directable from the inlet to the outlet.

According to another aspect of the invention, a gas turbine engine is provided and includes an outer vessel, an inner vessel disposed within the outer vessel to define an annulus through which a first fluid travels in a first direction, the inner vessel having first and second inner vessel portions defining an interior and an injector apparatus disposed within the outer vessel between the first and second inner vessel portions and including an annular inlet in which a portion of the first fluid traveling in the first direction is mixed with a second fluid to form a mixture, an annular outlet disposed downstream from the inlet from which the mixture is injected into the interior in a third direction, and an annular intermediate section fluidly interposed between the inlet and the outlet and along which the mixture is re-directable from the inlet to the outlet.

According to yet another aspect of the invention, a gas turbine engine in which fluids produced in a combustor are communicated through a transition piece is provided and includes an outer vessel formed of a combustor flow sleeve sealably coupled at an aft end thereof to a forward end of a transition piece outer liner, an inner vessel disposed within the outer vessel to define an annulus through which airflow travels axially forward, the inner vessel defining an interior therein and being formed of a combustor liner and a transition piece inner liner and an injector apparatus disposed within the outer vessel and between the combustor liner and the transition piece inner liner and including a body by which a portion of the airflow is mixed with fuel to form a mixture and from which the mixture is injected into the interior in an aft axial direction.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side sectional view of an injector apparatus according to embodiments;

FIG. 2 is a side sectional view of an injector apparatus according to alternative embodiments; and

FIG. 3 is a perspective view of the injector apparatus of FIG. 2.

The detailed description explains embodiments of the invention, together with advantages and features, by way of example with reference to the drawings.

### DETAILED DESCRIPTION OF THE INVENTION

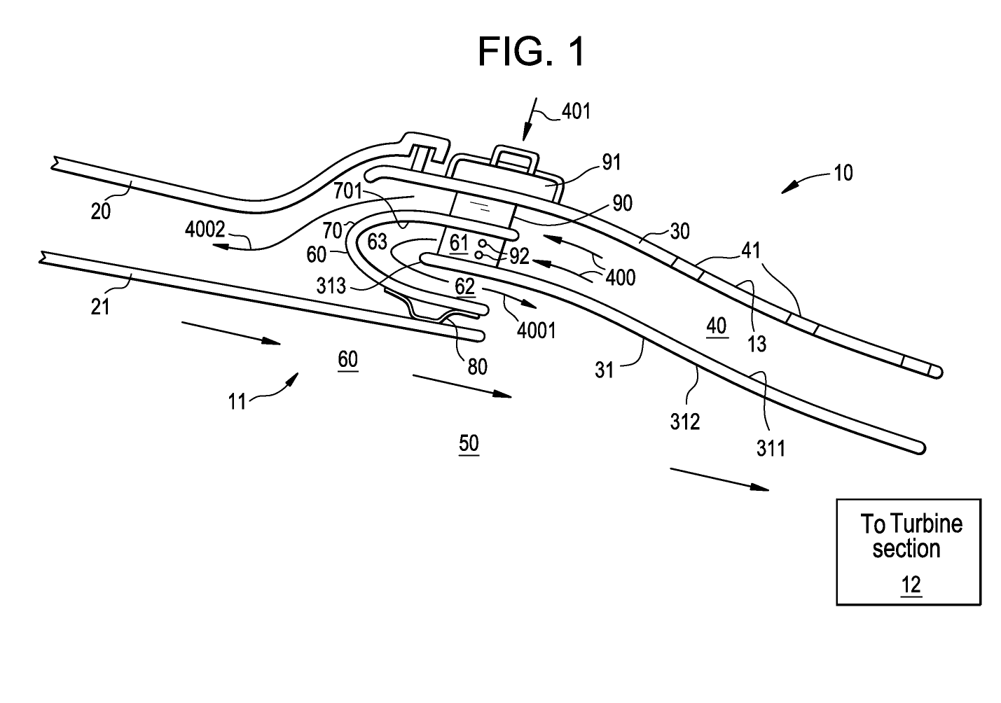

With reference to FIG. 1, a gas turbine engine 10 is provided in which a mixture of fuel and air is combusted within a combustor 11 to generate high energy and high temperature fluids that are communicated to a turbine section 12 where turbine blades expand the fluids to generate power and electricity. A transition piece 13 is fluidly interposed between the combustor 11 and the turbine section 12 such that the fluids being communicated from the combustor 11 to the turbine section 12 pass through the transition piece 13.

The combustor 11 may be formed of a combustor flow sleeve 20 and a combustor liner 21. The combustor flow sleeve 20 and the combustor liner 21 each have an annular shape with the combustor liner 21 disposed within the combustor flow sleeve 20. Similarly, the transition piece 13 may be formed of an outer transition piece liner 30 and an inner transition piece liner 31 with the inner transition piece liner 31 being disposed within the outer transition piece liner 30. The combustor flow sleeve 20 and the outer transition piece liner 30 are sealably coupled at an aft end of the combustor flow sleeve 20 and at a forward end of the outer transition piece liner 20 to form an outer vessel while the combustor liner 21 and the inner transition piece liner 31 may be separate from one another with complementary ends axially overlapped to form an inner vessel.

The inner vessel is therefore disposed within the outer vessel to define an annulus 40 through which a first fluid 400, such as compressor discharge air, flows in a first or forward axial direction. The compressor discharge air is output from a compressor of the gas turbine engine 10 and enters the annulus 40 through impingement holes 41 defined in the outer transition piece liner 30. The inner vessel is further formed to define an interior 50 through which a main flow of the fluids produced in the combustor 11 pass as they are communicated to the turbine section 12.

The gas turbine engine 10 further includes an injector apparatus 60 that acts as a reversed axial flow injector. The injector apparatus 60 is disposed within the outer vessel and between the combustor liner 21 and the inner transition piece liner 31 and includes an annular inlet 61, an annular outlet 62 and an intermediate section 63. Within the annular inlet 61, a portion of the first fluid 400 traveling in the first direction is mixed with a second fluid 401 traveling in a second direction to form a mixture. The annular outlet 62 is disposed downstream from the annular inlet 61 whereby the mixture is injected into the interior 50 in a third or aft axial direction. The annular intermediate section 63 is fluidly interposed between the annular inlet 61 and the annular outlet 62 whereby the mixture flows through the annular intermediate section 63 and is re-directed from the annular inlet 61 to the annular outlet 62. The annular intermediate section 63 may be defined radially inwardly from the annular inlet 61 and the annular outlet 62 may be defined radially inwardly from the annular intermediate section 63.

The injector apparatus 60 may be configured such that the injection of the mixture into the interior 50 is axially aligned with the flow of the first fluid 40 through the annulus 40 in the first direction. Alternatively, the injection may be axially angled or swirled with respect to the first direction. Swirling may create more shear between the mixture and the main flow of the fluids through the interior 50 thus improving mixing of airflow and the main flow of the fluids. Swirling may be provided by a shape of the injector apparatus 60 and/or by baffles disposed therein.

In accordance with the embodiments of FIG. 1, the injector apparatus 60 may be formed of a fully circumferential annular member 70 having a surface 701. The annular member 70 is formed such that annular inlet 61 is defined between the surface 701 and an outwardly facing surface 311 of the inner transition piece liner 31, the annular outlet 62 is defined between the surface 701 and an inwardly facing surface 312 of the inner transition piece liner 31, and the annular intermediate section 63 is defined between the surface 701 and an edge 313 of the inner transition piece liner 31.

The annular member 70 may be radially separate from the combustor flow sleeve 20 and the outer transition piece liner 30 of the outer vessel and may be sealed to the combustor liner 21 of the inner vessel by seal 80. In this way, a portion 4001 of the first fluid 400 traveling in the first direction at a radial location proximate to the outwardly facing surface 311 of the inner transition piece liner 31 enters the annular inlet 61. By contrast, the remaining portion 4002 of the first fluid 400 traveling in the first direction at a radial location proximate to the outer transition piece liner 30 passes outside the annular member 70 and continues on through the annulus 40.

The annular member 70 may have a c-shaped cross-section to encourage smooth fluid flow through the annular inlet 61, the annular outlet 62 and the annular intermediate section 63. However, it is to be understood that alternate embodiments are possible in which the annular member 70 has other cross-sectional shapes. These other cross-sectional shapes may be regular and/or irregular and curved and/or angular.

The gas turbine engine 10 may further include a peg 90. The peg 90 may have varied designs similar to those of quaternary fuel pegs, pegs used in swirlers and/or aerodynamic vanes. In any case, the peg 90 extends from a fuel plenum 91 at an exterior of the outer transition piece liner 30 of the outer vessel to at least the annular inlet 61. The peg 90 has a generally hollow body with injection holes 92 defined therein at the radial location corresponding to the annular inlet 61 through which the second fluid 401 is to be supplied to the annular inlet 61.

The peg 90 may be plural in number with the plurality of the pegs 90 arrayed circumferentially along the circumferential extent of the annular member 70. In this case, the second fluid 401 travels through each peg 90 in a radial direction and is injected into the flow of the fluid 400 in a circumferential direction. Thus, the first and second fluids 400, 401 at least initially travel in traverse directions with respect to one another.

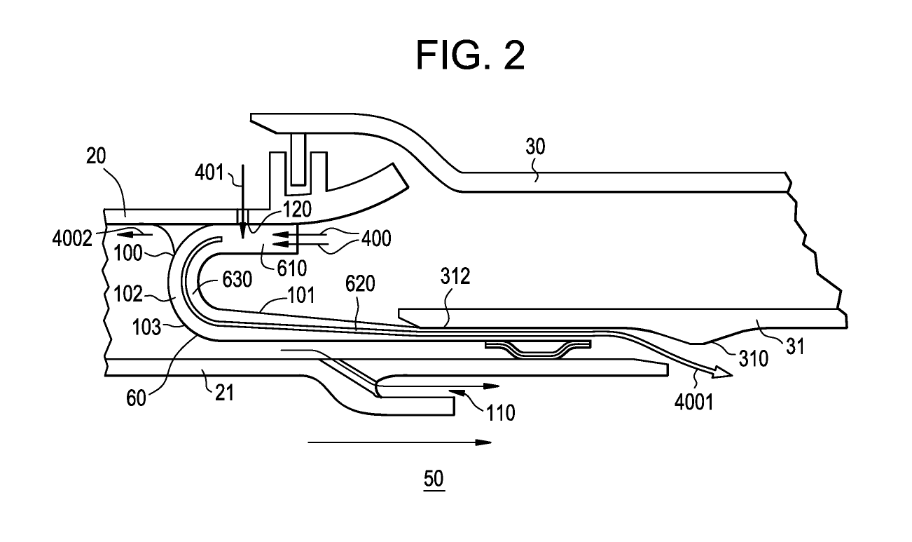

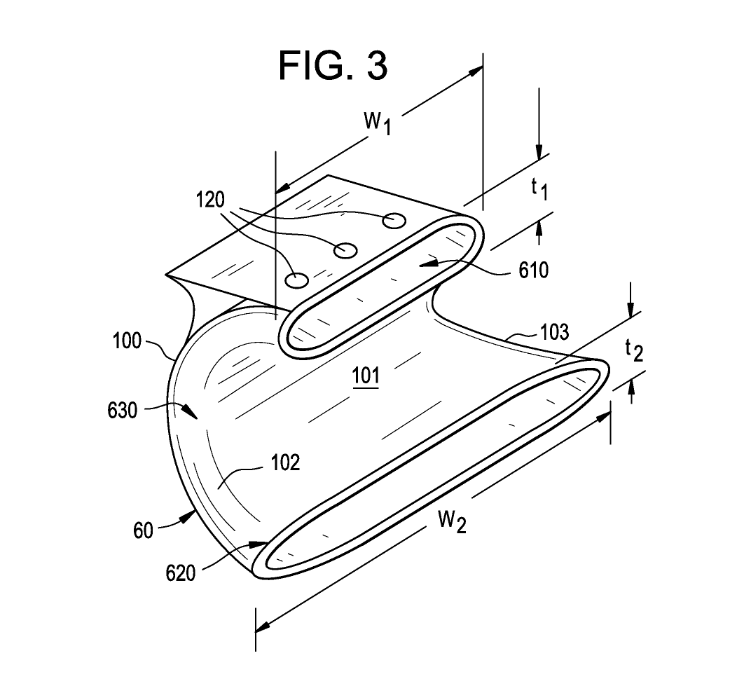

An alternative embodiment of the injector apparatus 60 is illustrated in FIGS. 2 and 3. As shown in FIGS. 2 and 3, the annularly segmented inlet 610, the annularly segmented outlet 620 and the annularly segmented intermediate section 630 are each segmented in the circumferential direction and defined between an annularly segmented outer wall 100, an annularly segmented inner wall 101 and opposing sidewalls 102, 103 that extend between the annularly segmented outer wall 100 and the annularly segmented inner wall 101.

In the embodiments, of FIGS. 2 and 3, the annularly segmented outer wall 100 is disposed to contact the combustor flow sleeve 20 of the outer vessel and the annularly segmented inner wall 101 is disposed to contact the inwardly facing surface 312 of the inner transition piece liner 31. In this case, the annularly segmented outer wall 100 is otherwise separate from the combustor liner 31 to define a cooling air slot 110. In this way, the portion 4001 of the first fluid 400 traveling in the first direction at a circumferential location corresponding to the injector apparatus 60 enters the annularly segmented inlet 610. By contrast, the remaining portion 4002 of the first fluid 400 traveling in the first direction at a circumferential location that does not correspond to the injector apparatus 60 passes to a side of the injector apparatus 60 and continues on through the annulus 40.

As shown in FIG. 3, the injector apparatus 60 may be formed such that at least the annularly segmented inlet 610 and the annularly segmented outlet 620 have different shapes and/or sizes. For example, both the annularly segmented inlet 610 and the annularly segmented outlet 620 may be oval-shaped. However, the annularly segmented inlet 610 may have a first width, w₁, and a first thickness, t₁, while the annularly segmented outlet 620 may have a second width, w₂, which is wider than the first width, w₁, and a second thickness, t₂, which is thinner than the first thickness, t₁.

The annularly segmented outer wall 100 and the annularly segmented inner wall 101 may each have a c-shaped cross-section to encourage smooth fluid flow through the annularly segmented inlet 610, the annularly segmented outlet 620 and the annularly segmented intermediate section 630. However, it is to be understood that alternate embodiments are possible in which the annularly segmented outer wall 100 and/or the annularly segmented inner wall 101 have other cross-sectional shapes. These other cross-sectional shapes may be regular and/or irregular and curved and/or angular.

The annularly segmented outer wall 100 is formed to define a hole 120 through which the second fluid 401 is to be supplied to the annularly segmented inlet 610. The hole 120 may be plural in number with the plurality of the holes 120 arrayed circumferentially. In this case, the second fluid 401 travels through each hole 120 and is injected into the flow of the fluid 400 in a radial direction. Thus, the first and second fluids 400, 401 at least initially travel in traverse directions with respect to one another.

As shown in FIG. 2, in a further embodiment, the inner transition piece liner 31 may include a baffle 310 or surface formation immediately downstream from the annularly segmented outlet 62. This baffle 310 serves to direct the injected mixture toward the interior 50. Meanwhile, a flow of coolant through the cooling air slot 110 may entrain the flow of the injected mixture proximate to the inner transition piece liner 31.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An injector apparatus, comprising:
an annular inlet in which a first fluid traveling in a first direction is mixable with a second fluid to form a mixture;
an annular outlet disposed downstream from the inlet from which the mixture is injectable into a main flow in a third direction; and
an annular intermediate section fluidly interposed between the inlet and the outlet and along which the mixture is re-directable from the inlet to the outlet.

2. The injector apparatus according to claim 1, wherein the first and third directions are substantially aligned or angled with respect to one another.

3. The injector apparatus according to claim 1, wherein the inlet, the outlet and the intermediate section are each defined along a surface of an annular member.

4. The injector apparatus according to claim 3, wherein the annular member has a c-shaped cross section.

5. The injector apparatus according to claim 1, further comprising a peg to supply the second fluid to the inlet.

6. The injector apparatus according to claim 1, wherein the inlet, the outlet and the intermediate section are each annularly segmented.

7. The injector apparatus according to claim 6, wherein the annularly segmented inlet, the annularly segmented outlet and the annularly segmented intermediate section are each defined between an annularly segmented outer wall, an annularly segmented inner wall and opposing sidewalls extending between the annularly segmented outer and inner walls.

8. The injector apparatus according to claim 7, wherein the annularly segmented outer wall and the annularly segmented inner wall each has a c-shaped cross section.

9. The injector apparatus according to claim 7, wherein the annularly segmented outer wall is formed to define a hole through which the second fluid is to be supplied to the inlet.

10. The injector apparatus according to claim 6, wherein the annularly segmented inlet and the annularly segmented outlet differ in shape and/or size.

11. A gas turbine engine, comprising:
an outer vessel;
an inner vessel disposed within the outer vessel to define an annulus through which a first fluid travels in a first direction, the inner vessel having first and second inner vessel portions defining an interior; and
an injector apparatus disposed within the outer vessel between the first and second inner vessel portions and including:
an annular inlet in which a portion of the first fluid traveling in the first direction is mixed with a second fluid to form a mixture,
an annular outlet disposed downstream from the inlet from which the mixture is injected into the interior in a third direction, and
an annular intermediate section fluidly interposed between the inlet and the outlet and along which the mixture is re-directable from the inlet to the outlet.

12. The gas turbine according to claim 11, wherein the first and third directions are substantially aligned or angled with respect to one another.

13. The gas turbine engine according to claim 11, wherein the second inner vessel portion is aft of the first inner vessel portion and:
the inlet is defined between a surface of an annular member and an outwardly facing surface of the second inner vessel portion,
the outlet is defined between the surface of the annular member and an inwardly facing surface of the second inner vessel portion, and
the intermediate section is defined between the surface of the annular member and an edge of the second inner vessel portion.

14. The gas turbine engine according to claim 13, wherein the annular member is separate from the outer vessel and sealed to the first inner vessel portion.

15. The gas turbine engine according to claim 13, wherein the annular member has a c-shaped cross section.

16. The gas turbine engine according to claim 13, further comprising a peg to supply the second fluid to the inlet.

17. The gas turbine engine according to claim 13, wherein the inlet, the outlet and the intermediate section are each annularly segmented and defined between an annularly segmented outer wall, an annularly segmented inner wall and opposing sidewalls extending between the annularly segmented outer and inner walls.

18. The gas turbine engine according to claim 17, wherein the second inner vessel portion is aft of the first inner vessel portion, the annularly segmented outer wall contacts the outer vessel and the annularly segmented inner wall contacts an inwardly facing surface of the second inner vessel portion.

19. The gas turbine engine according to claim 17, wherein the annularly segmented outer wall and the annularly segmented inner wall each has a c-shaped cross section.

20. The gas turbine engine according to claim 17, wherein the annularly segmented outer wall is formed to define a hole through which the second fluid is to be supplied to the inlet.

21. The gas turbine engine according to claim 17, wherein the annularly segmented inlet and the annularly segmented outlet differ in shape and/or size.

22. A gas turbine engine in which fluids produced in a combustor are communicated through a transition piece, the gas turbine engine comprising:
an outer vessel formed of a combustor flow sleeve sealably coupled at an aft end thereof to a forward end of a transition piece outer liner;
an inner vessel disposed within the outer vessel to define an annulus through which airflow travels axially forward, the inner vessel defining an interior therein and being formed of a combustor liner and a transition piece inner liner; and
an injector apparatus disposed within the outer vessel and between the combustor liner and the transition piece inner liner and including a body by which a portion of the airflow is mixed with fuel to form a mixture and from which the mixture is injected into the interior in an aft axial direction.
